(19) United States
(12) Patent Application Publication
(10) Pub. No.: US 2007/0022971 A1
(43) Pub. Date: Feb. 1, 2007

(54) Pet treat-dispensing toy

(76) Inventors: Jack W. Renforth, Aurora, CO (US); Larry Deliman, Englewood, CO (US); Charles Costello, Louisville, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/353,931

(22) Filed: Feb. 13, 2006

Related U.S. Application Data
(60) Provisional application No. 60/702,690, filed on Jul. 26, 2005.

(51) Int. Cl. A01K 29/00

(52) U.S. Cl. 119/707

(57) ABSTRACT

A treat-dispensing toy for pets. The embodiment may dispense a substance, such as a treat, when a pet interacts with the embodiment. The embodiment may include a body; an interior chamber defined within the body; a first planar surface formed within the interior chamber; an opening formed in the body and communicating with the interior chamber; wherein the interior chamber is adapted to hold the substance; and the opening is adapted to pass the substance to the interior chamber. Further, the embodiment may include a passage extending from the opening to the interior chamber, the passage at least partially defined by the first planar surface. The embodiment may also include a second planar surface formed within the interior chamber; and a second opening formed in the body and communicating with the interior chamber.

### CROSS-REFERENCE TO RELATED APPLICATION

This application claims the benefit under 35 U.S.C. 119(e) of U.S. provisional patent application No. 60/702,690, filed Jul. 26, 2005 and entitled “Pet Treat-Dispensing Toy”, the disclosure of which is hereby incorporated herein in its entirety.

### BACKGROUND OF THE INVENTION

1. Technical Field

The present invention relates generally to a pet toy, and more specifically to an ellipsoid-shaped pet toy having a hollow formed therein for containing treats, and at least one opening for dispensing said treats.

2. Background

Pet owners interact with their domesticated animals on many levels and in many activities. Continued, steady interaction not only facilitates bonding between owner and animal, but brings both happiness. One common method of owner-animal interaction is feeding treats to a pet.

Domesticated animals enjoy treats, and will often go to great lengths to obtain them. Many owners place treats inside a container designed to dispense the treats when the animal interacts with the container. For example, some containers drop treats when the pet bats at or moves the container.

However, many treat containers and/or treat-dispensing toys require disassembly to place the treat in the container. For example, some spherical treat-dispensing toys require the sphere be opened by unscrewing opposing halves of the toy in order to place treats within. This may be irritating and time-consuming for a pet owner, ultimately decreasing the utility of the container and the number of times an owner is willing to place treats into the container.

Yet other treat-dispensing containers fail to hold a pet's interest. For example, many treat-dispensing containers move in a predictable fashion when a domesticated animal bats, pushes, or rolls the container. Still other containers are opaque, and so the treats contained within cannot provide a visual stimulus to encourage animal interaction. Still other containers dispense treats in a predictable fashion, such as providing a treat every time the container is moved or oriented in a specific fashion. Further, many containers limit or eliminate a pet's ability to smell or hear the treat contained inside. Any or all of these limitations may reduce a pet's interest in interacting with the treat container.

Accordingly, there is a need in the art for an improved pet treat-dispensing toy.

### SUMMARY OF THE INVENTION

Generally, one embodiment of the present invention takes the form of a treat-dispensing toy for pets. The embodiment may dispense a substance, such as a treat, when a pet interacts with the embodiment.

The embodiment may include a body; an interior chamber defined within the body; a first planar surface formed within the interior chamber; an opening formed in the body and communicating with the interior chamber; wherein the interior chamber is adapted to hold the substance; and the opening is adapted to pass the substance to the interior chamber. Further, the embodiment may include a passage extending from the opening to the interior chamber, the passage at least partially defined by the first planar surface. The embodiment may also include a second planar surface formed within the interior chamber; and a second opening formed in the body and communicating with the interior chamber.

In some embodiments of the present invention, the first planar surface may at least partially obstruct the first opening, and the second planar surface may at least partially obstruct the second opening. The passage may extend from the first opening to the second opening, forming a serpentine shape.

The embodiment may assume a variety of shapes. For example, the embodiment may be football-shaped, and may include markings or surface detailings to enhance the resemblance to a football. The football shape facilitates a wobbling, unpredictable motion when the object is struck or moved by a pet. A portion of the body may be transparent to permit a pet or pet owner to see the treat (or other object) contained within the embodiment.

Generally, the embodiment is sized to accept and dispense a treat or other object without requiring the embodiment be opened or disassembled. In this manner, an owner may conveniently place a treat within the body.

These and other advantages of the present invention will become apparent upon reading the following detailed description.

### BRIEF DESCRIPTION OF THE DRAWINGS

FIG. 1 depicts a perspective view of a first embodiment of the present invention.

FIG. 2 depicts a second perspective view of the first embodiment, showing a transparent side of the embodiment.

FIG. 3 depicts a front view of the first embodiment.

FIG. 4 depicts a rear view of the first embodiment.

FIG. 5 depicts a left view of the first embodiment.

FIG. 6 depicts a right view of the first embodiment.

FIG. 7 depicts a top view of the first embodiment.

FIG. 8 depicts a bottom view of the first embodiment.

FIG. 9 depicts an exploded view of the first embodiment.

FIG. 10 depicts an perspective view of a second embodiment of the present invention.

FIG. 11 depicts a front view of the second embodiment.

FIG. 12 depicts a rear view of the second embodiment.

FIG. 13 depicts a left view of the second embodiment.

FIG. 14 depicts a right view of the second embodiment.

### DETAILED DESCRIPTION

Generally, one embodiment of the present invention takes the form of a treat-dispensing toy for pets. The present embodiment takes the form of a football-shaped, partially-hollow construction, flattened and open at both ends. These end openings are sized such that a pet treat may be placed into or exit the toy. In the present embodiment, the holes are approximately one and three-quarters inches in diameter.

One or more planar members project inwardly, from an inner sidewall of the toy, into the hollow. Typically, although not necessarily, the planar members are angularly offset from the longitudinal and vertical planes of the toy. The longitudinal and vertical planes are the planes containing the longitudinal and vertical axes, respectively, and are at right angles to one another.

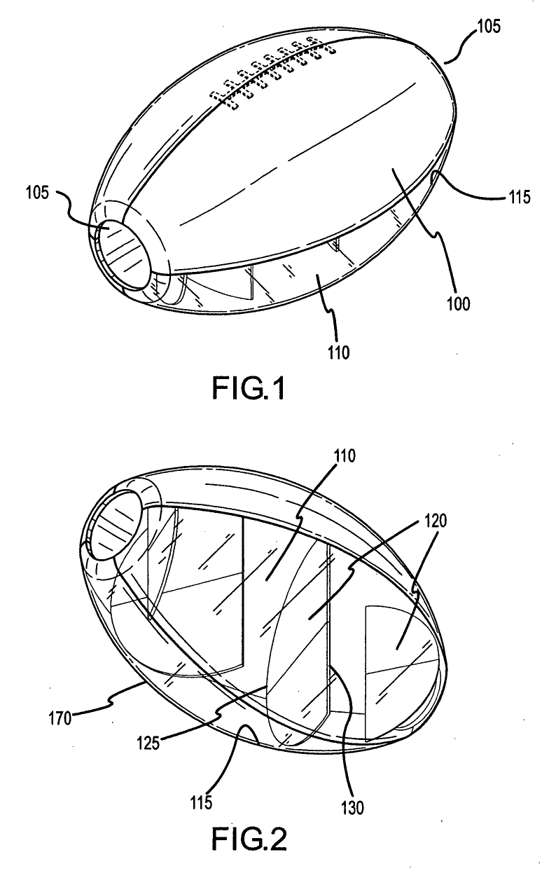

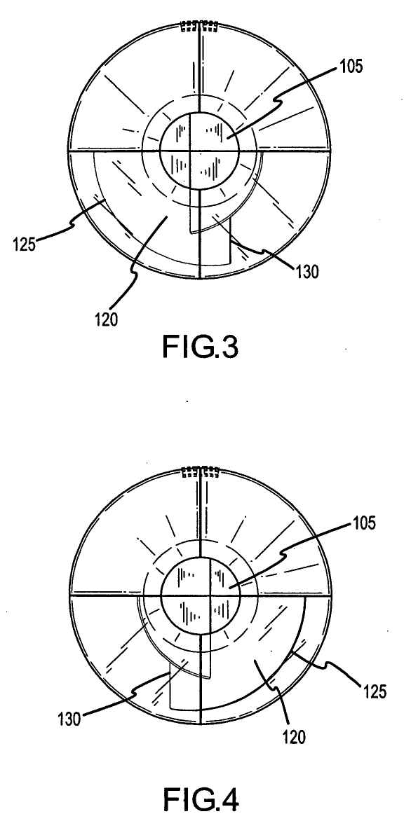

FIGS. 1 and 2 depict perspective views of the present embodiment. As previously mentioned, the toy 100 is generally football-shaped, with openings 105 at either flattened end. Treats may be inserted into the hollow 110 defined by the toy sidewall 115 through either opening 105. The openings are shown to best effect in FIGS. 3 and 4.

Returning to FIGS. 1 and 2, one half of the toy 100 is typically transparent or translucent. Generally, toy 100 is transparent along its length, rather than its width, to permit a domestic animal to view the treats inside the toy 100. This, in turn, motivates the animal to play with the toy 100 and attempt to retrieve the treats from the hollow 110.

The football shape of the embodiment promotes a wobbling, non-linear motion as a domestic animals plays with the toy 100. This wobbling motion may enhance the animal's curiosity, and thus prolong the animal's interaction with the toy 100.

The embodiment includes one or more planar surfaces 120 formed in the hollow interior chamber 110. Each planar surface 120 includes an arcuate end 125 and an opposing end 130. The arcuate end 125 generally contacts the embodiment's inner sidewall 115 along the entirety of the arcuate end 125, while the opposing end 130 typically does not contact the inner sidewall 115. Thus, no single planar surface 120 extends across the entirety of the interior chamber 110.

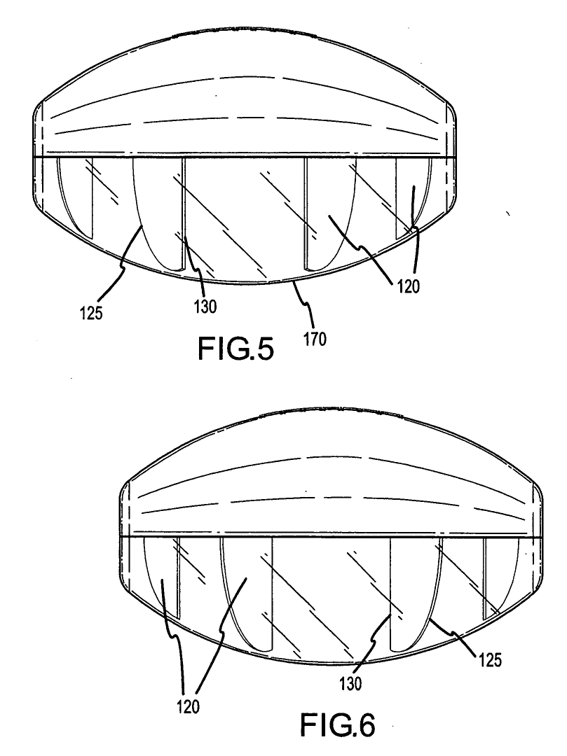

The inner planar surfaces 120 generally extend at angle to both the longitudinal and lateral axes of the embodiment, as shown to best effect in FIG. 2 and the exploded view of FIG. 9. In the present embodiment, the planar surfaces 120 extend at approximately a thirty degree or sixty-degree angle to the lateral axis. The central two planar surfaces 140 extend inwardly at approximately a thirty degree angle from the lateral axis, while the bottom two planar surfaces 135 extend outwardly at approximately a sixty-degree angle from the same axis. Alternate embodiments, however, may vary the angles of extension for one or all planes 120. Each planar surface 120 may, for example, have a different angle of extension. The planar surfaces are also depicted in side view in FIGS. 5 and 6.

As shown in FIGS. 2, 3, 4, and 8, each planar surface 120 extends sufficiently far within the interior chamber that its length overlaps at least one other planar surface's length. That is, the opposing end 130 of each planar surface extends past the opposing end 130 of at least one other planar surface 120. Each planer member 120 extends beyond the centerline (longitudinal axis) of the body in the present embodiment.

In the present embodiment, the lengths of the two outer planar surfaces 135 are identical, as are the lengths of the two inner planar surfaces 140. Since each outer planar surface 135 overlaps each inner planar surface 140, there is no straight-line path defined through the interior chamber 110 of the embodiment. Rather, the planar surfaces 120 cooperate to define a serpentine path, as well as a second chamber 145 formed between the two inner planar surfaces 140. A third chamber 150 is formed by the two outer planar surfaces 135. The second 145 and third 150 chambers are in communication with one another, and the third chamber 150 is a segment of the serpentine path. Both the second 145 and third 150 chambers are defined within the embodiment's interior chamber 110.

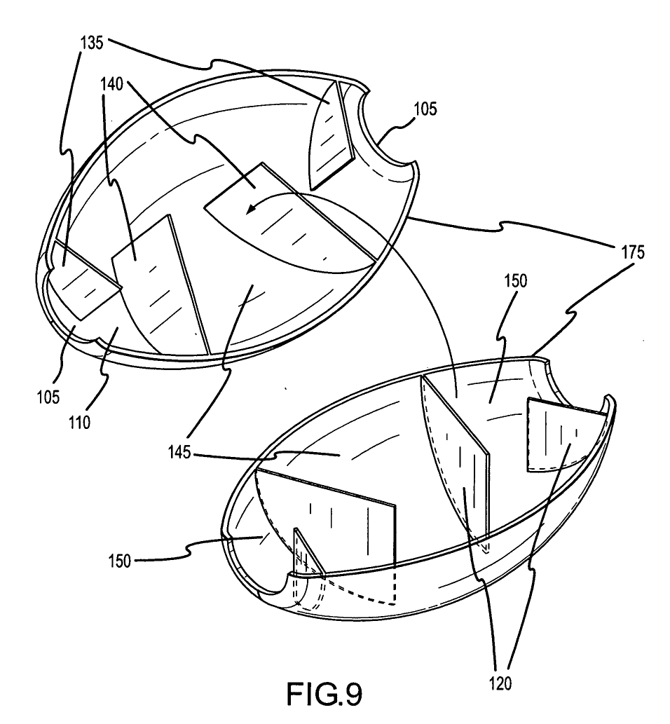

Generally, the angulation of the planar surfaces 120 is such that the portions of the serpentine passage occurring between adjacent members are smaller in dimension than any of the interior 110, second 145, or third 150 chambers. This narrowing occurring at certain segments of the serpentine passage ensures that objects placed within the second 145 or third 150 chamber do not readily exit the interior chamber 110 through either of the end holes 105. Each narrow portion of the serpentine path (“choke points” 155) is generally formed by the opposing ends 130 of an outer planar segment 135 and adjacent inner planar segment 140. The angulation of adjacent inner 140 and outer planar segments 135, as shown in FIG. 8, serves to define these choke points 155.

A similar, relatively narrow passage 160 is formed by the opposing ends 130 of the two inner planar surfaces 140. This narrow passage 160 links the second 145 and third chambers 150. As shown in the figures, the length of the second chamber 145 is greater at its end near the embodiment's inner sidewall than the length defined between the inner planar surfaces'opposing ends 130. Thus, properly-shaped objects passing from the third 150 to the second 145 chamber through this relatively narrow passage 160 may be retained in the second chamber 145 for a time, until the objects are properly aligned to pass back through the narrow passage. For example, an object having a length greater than its width and/or height (such as a thin cylindrical or rectangular object) may pass through the relatively narrow passage 160 into the second chamber 145 from the third chamber 150, when the object is oriented with its longest dimension perpendicular to the embodiment's longitudinal axis. Once inside the second chamber 145, the object may freely rotate to change its angle relative to the embodiment's longitudinal axis. This may confine the object in the second chamber 145 until the object's orientation once again changes.

In a similar manner, such objects may be confined in the third chamber 150 by the choke points 155 defined in the serpentine path. Thus, objects placed within the second 145 or third 150 chambers may be retained therein until the objects'orientation permits their passage through the choke points.

One embodiment of the present invention is particularly suitable for use as an animal play toy, and may contain animal treats. For example, animal treats (edible or otherwise) may be inserted into the interior chamber 110 by a pet owner and guided by shaking or turning the embodiment until the treat is received in either the second chamber 145 or third chamber 150. These chambers are shown in FIG. 8.

Once the treat is in either the second 145 or third 150 chambers, the planar surfaces 120 prevent the treat from exiting the interior chamber 110 without manipulating the embodiment. The planar surfaces 120 are angled such that, if the embodiment is placed on one end, the treat is received in an angled pocket 165 created by the intersection of a planar surface 120 and the interior sidewall 115. As shown in FIG. 8, the angled planar surfaces 120 direct the object to the bottom of the pocket 165. Once the object/treat is received in the bottom of the angle pocket 165, the embodiment must be manipulated to free the object from the pocket 165. Sufficient manipulation, by a person or animal, will cause the object/treat to move along the serpentine path from the interior chamber 110, through a choke point 155, and out the end holes 105. At this point, the animal may chew or play with the treat.

Since the embodiment is open at both ends and a serpentine path is defined throughout, animals may smell food or other treats placed within the interior chamber 110. The smell of such treats may enhance the animal's desire to play with or otherwise manipulate the present invention, in order to free the treat from the interior chamber 110.

Similarly, the present embodiment includes a translucent or transparent panel 170 covering one half its surface, as shown in FIGS. 2-6. This panel permits an animal to see the treat inside the interior chamber, which may again enhance the animal's desire to play with the present invention in order to retrieve the treat. In alternate embodiments, the entire surface of an embodiment may be translucent or transparent, or a different portion (one third, three quarters, etc.) of the surface may be translucent or transparent. Yet other embodiments may include alternating see-through and opaque strips, or include windows permitting an animal to view a treat contained in the interior chamber.

The embodiment (including the planar surfaces 120) is generally made of a hard material, such as a plastic. One exemplary material used to manufacture certain embodiments of the present embodiment is a rubber-modified, high impact styrene. Alternate embodiments may be made from different materials.

Since the embodiment is typically manufactured from a relatively hard material, certain objects (such as most edible pet treats) placed inside the inner chamber 110 make an audible noise when they impact a surface 115 of the embodiment. This may occur, for example, when the embodiment is pushed, shaken, or otherwise moved. As a further example, an animal rolling or batting the embodiment may cause the object to rattle against the inner surfaces 115 of the embodiment. Such noise may attract the animal to the embodiment, resulting in the animal playing with the embodiment and evincing interest therein.

The embodiment is generally assembled by molding two halves 175 separately. The halves are shown in FIG. 9. The planar surfaces 120 may be integrally formed with either half, or some surfaces formed with each half. As an alternative, the planar surface 120 may be separately formed and attached to one or both halves 175 by heat sealing, sonic welding, or an adhesive. The halves 175 are attached to one another in a similar manner. The exploded view shown in FIG. 9 generally depicts the two halves 175 of an embodiment, with a portion of each planar surface 120 formed integrally with each half 175. When the halves 175 are sealed together, so are the corresponding portions of each planar surface 120.

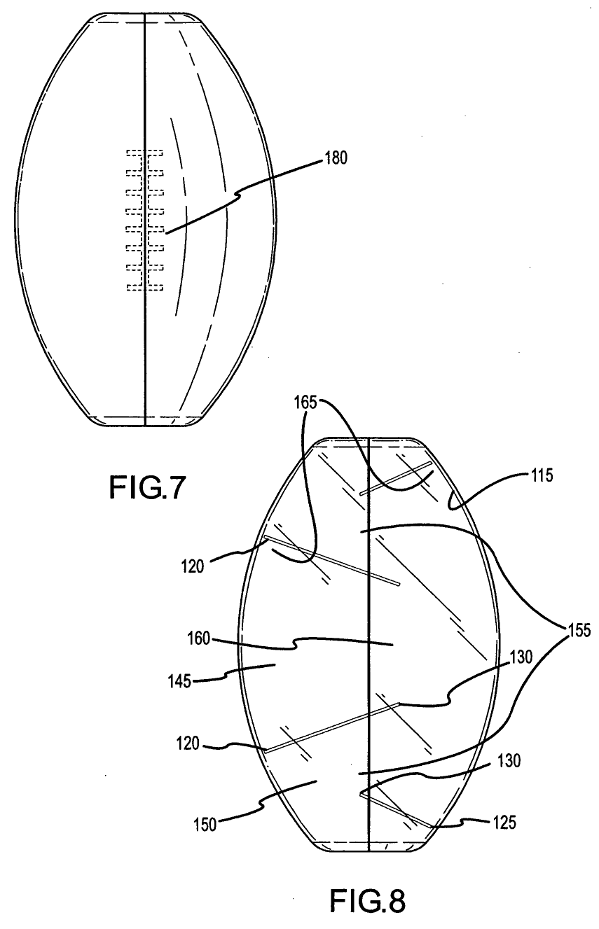

As previously noted, the embodiment depicted in FIGS. 1-9 is generally shaped like a football. As shown to best effect in FIG. 7, the embodiment may include surface detailing to enhance the resemblance to a football. In this case, the surface detailing takes the form of a raised plastic element 180 designed to emulate stitching on a football. In addition to the stitching, the embodiment may include other decorative designs or words.

Alternate embodiments may be shaped like a variety of other objects, including different sports objects. For example, some embodiments may be shaped like a baseball, basketball, baseball bat, and so forth. Surface detailing may be used to enhance the resemblance.

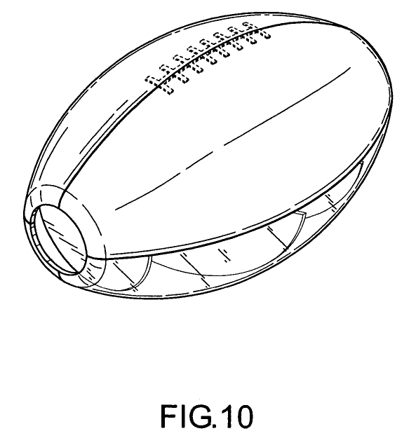

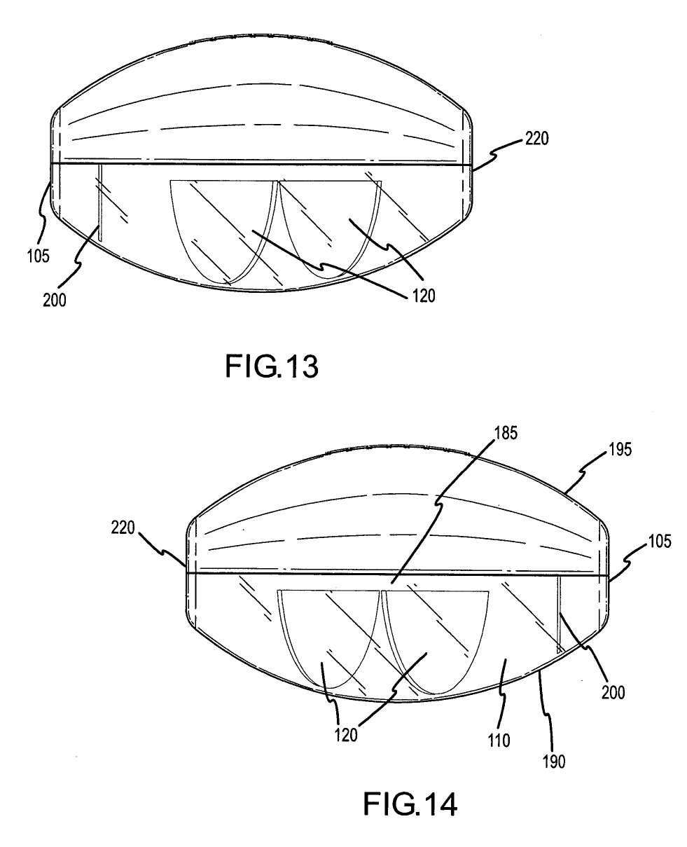

An alternative embodiment of the present invention, shown generally in FIGS. 10-14, has an outer structure similar or identical to the embodiment described with respect to FIGS. 1-9. However, the present embodiment does not employ angled planar surfaces 120. Instead, at least two of the interior planar surfaces 120 are generally parallel, as shown in FIGS. 10, 13 and 14. Parallel planar surfaces 120 are formed in the present embodiment along each longitudinal half, but do not extend across the entire half. Accordingly, a gap 185 between the planar surfaces 120 formed in the transparent longitudinal half 190 and the opaque longitudinal half 195 exists. This gap 185 forms a relatively straight passage, as shown in FIGS. 13 and 14. Objects may enter the interior of the embodiment through the straight passage and be received between any two of the parallel planar surfaces 120, for dispensing when the embodiment is moved or rolled.

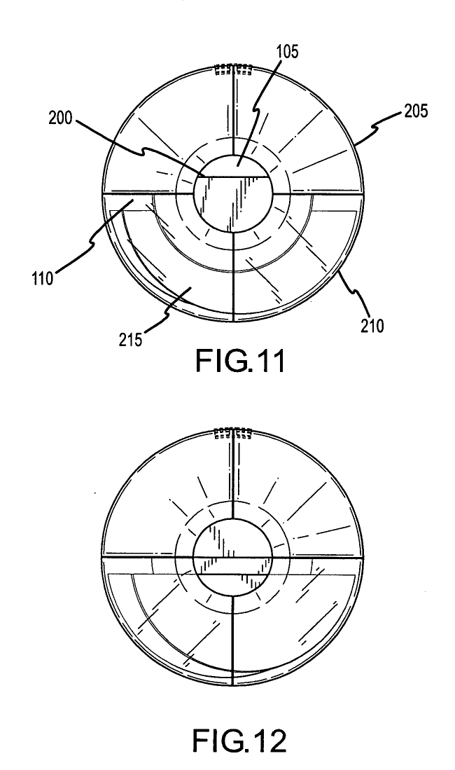

As shown in FIG. 11, an end plate 200 may block objects received in the interior cavity 110 from immediately exiting the embodiment through the opening 105. The end plate extends downwardly from a first half of the embodiment 205, and is formed integrally therewith. The end plate 200 is parallel to the opening or openings 105. The end plate 200 may extend to contact the sidewall of the second, opposing half of the embodiment 210, forcing objects to enter the inner chamber 110 from the opening 105 by passing through a gap 215 defined between the end plate 200 and the first half 205.

By contrast, the planar surfaces 120 are angularly and laterally offset from the end plate 200 and opening 105, as shown in FIGS. 13 and 14. The planar surfaces 120 are formed integrally with the second half of the embodiment 190. Additional planar surfaces 120 may be formed in the first half 195, generally mirroring the placement and alignment of the planar surfaces 120 shown in FIGS. 13 and 14.

The embodiment may include a second end plate (not shown) at the end opposite the end plate 200 shown in FIGS. 13 and 14. The second end plate functions in a manner similar to the end plate 200 described above. Effectively, the end plate 200 defines a passage starting at the associated opening, extending upward into the first (here, opaque) half 195, around the top of the end plate 200, and down into the interior chamber 110. The planar surfaces 120 define a variety of cavities within the interior chamber 110. If the first half 195 includes planar surfaces 120 mirroring the placement of the planar surfaces 120 in the second half 190, the first 195 and second 190 half planar surfaces 120 cooperate to continue the aforementioned passage in a relatively straight line coplanar with the embodiment's longitudinal axis. The passage snakes about the second end plate (if present) to terminate at the second opening 220, following a path similar to that described with respect to the first end plate 200.

Yet other embodiments may include structural variants. For example, the planar surfaces 120 may extend across an entirety of an axis of the interior chamber 110 (i.e., may extend to block the interior chamber 110 from an opening in an end 105), and holes may be defined in each planar surface 120. In this manner, the serpentine passage may not be defined by the opposing ends 130 of each planar surface 120 and the inner sidewall 115, but instead by the placement of the holes through the planar surfaces 120. Further, the angles formed by the planar surfaces 120 and interior sidewall 115 may be varied. In yet other embodiments, the planar surfaces 120 may be replaced by strips or grates of material, instead of forming a contiguous surface. In yet other embodiments, caps may be included for one or both end holes 105. In still other embodiments, a hinge may permit the embodiment to be opened, so that treats may be more conveniently placed within the interior chamber 110. In embodiments that may be opened (such as the aforementioned hinged embodiment), a closing or locking mechanism may also be included to prevent an animal from opening the embodiment to get at a treat or other object within.

In addition to the embodiments described herein, alternative embodiments will become apparent to those skilled in the art upon reading this disclosure. Accordingly, the proper scope of the invention is defined by the following claims.

We claim:

1. A substance-dispensing pet toy, comprising:
a body;
an interior chamber defined within the body;
a first planar surface formed within the interior chamber;
an opening formed in the body and communicating with the interior chamber; wherein
the interior chamber is adapted to hold the substance; and
the opening is adapted to pass the substance to the interior chamber.

2. The substance-dispensing pet toy of claim 1, further comprising a passage extending from the opening to the interior chamber, the passage at least partially defined by the first planar surface.

3. The substance-dispensing pet toy of claim 2, further comprising:
a second planar surface formed within the interior chamber; and
a second opening formed in the body and communicating with the interior chamber.

4. The substance-dispensing pet toy of claim 3, wherein:
the first planar surface at least partially obstructs the first opening; and
the second planar surface at least partially obstructs the second opening.

5. The substance-dispensing pet toy of claim 4, wherein the second opening is formed on the body opposite the first opening.

6. The substance-dispensing pet toy of claim 4, wherein the body is football-shaped.

7. The substance-dispensing pet toy of claim 4, wherein:
the passage extends from the first opening to the second opening; and
the passage is serpentine.

8. The substance-dispensing pet toy of claim 4, wherein at least a portion of the body is transparent.

9. The substance-dispensing pet toy of claim 8, wherein the transparent portion of the body equals half the body.

10. The substance-dispensing pet toy of claim 7, further comprising a second chamber contained within the interior chamber, the second chamber at least partially defined by the first and second planar members.

11. The substance-dispensing pet toy of claim 10, further comprising:
a third planar surface formed within the interior chamber;
a fourth planar surface formed within the interior chamber;
a third chamber contained within the interior chamber, the third chamber at least partially defined by the third and fourth planar members.

12. The substance-dispensing pet toy of claim 11, wherein the first, second, third, and fourth planar members contact an inner sidewall of the body.

13. The substance-dispensing pet toy of claim 12, wherein the first, second, third, and fourth planar members are made of a hard plastic.

14. The substance-dispensing pet toy of claim 12, wherein:
the first planar member is offset from a longitudinal axis of the body by a first angle;
the second planar member is offset from a longitudinal axis of the body by a second angle;
the third planar member is offset from a longitudinal axis of the body by a third angle; and
the fourth planar member is offset from a longitudinal axis of the body by a fourth angle.

15. The substance-dispensing pet toy of claim 14, wherein:
the first, second, third, and fourth planar members slope inwardly towards a center point of the body.

16. The substance-dispensing pet toy of claim 15, wherein:
the first planar member extends a first distance;
the second planar member extends the first distance;
the third planar member extends a second distance;
the fourth planar member extends the second distance; wherein
the first and second planar members extend beyond a centerline of the body in a first direction; and
the third and fourth planar members extend beyond the centerline of the body in a second direction.

17. The substance-dispensing pet toy of claim 7, further comprising:
a third planar surface formed within the interior chamber;
a fourth planar surface formed within the interior chamber;
a third chamber contained within the interior chamber, the third chamber at least partially defined by the third and fourth planar members.

18. An animal play toy, comprising:
a generally football-shaped body, comprising:
a flattened first end;
a flattened second end;
a curved sidewall extending from the first end to the second end and defining an interior chamber;
a transparent window formed in the football-shaped body;
a first opening sized to accept a pet treat, formed in the first end;
a second opening sized to accept a pet treat, formed in the second end;
a first planar surface formed in the interior chamber; wherein
the first planar surface at least partially obstructs the interior chamber from the first opening.

19. The animal play toy of claim 18, further comprising:
a second planar surface formed in the interior chamber; wherein
the second planar surface at least partially obstructs the interior chamber from the second opening.

20. The animal play toy of claim 19, further comprising:
a first aperture defined in the first planar surface;
a second aperture defined in the second planar surface; wherein
the first and second planar surfaces extend across an axis of the interior chamber; and
the first and second apertures permit the first and second openings to communicate with the interior chamber, respectively.
